(19) United States
(12) Patent Application Publication
(10) Pub. No.: US 2026/0073930 A1
(43) Pub. Date: Mar. 12, 2026

(54) SMART DIALOGUE ENHANCEMENT BASED ON NON-ACOUSTIC MOBILE SENSOR INFORMATION

(71) Applicant: DOLBY LABORATORIES LICENSING CORPORATION

(72) Inventors: Kai LI, Beijing (CN); Libin LUO, Beijing (CN)

(73) Assignee: DOLBY LABORATORIES LICENSING CORPORATION, San Francisco, CA (US)

(21) Appl. No.: 19/104,685

(22) PCT Filed: Aug. 17, 2023
(86) PCT No.: PCT/US2023/072418

§ 371 Date: Feb. 18, 2025

Related U.S. Application Data
(60) Provisional application No. 63/432,813, filed on Dec. 15, 2022.

(30) Foreign Application Priority Data
Aug. 26, 2022 (WO) PCT/CN2022/115140
Jan. 10, 2023 (EP) 23150931.6

(51) Int. Cl. G10L 21/0216

(52) U.S. Cl. CPC G10L 21/0216

(57) ABSTRACT

Described herein is a method of performing environment-aware processing of audio data for a mobile device. In particular, the method may comprise obtaining non-acoustic sensor information of the mobile device. The method may further comprise determining scene information indicative of an environment of the mobile device based on the non-acoustic sensor information. The method may yet further comprise performing audio processing of the audio data based on the determined scene information.

### CROSS-REFERENCE TO RELATED APPLICATIONS

This application claims the benefit of priority from PCT Application No. PCT/CN2022/115140 filed on 26 Aug. 2022, U.S. Provisional Application Ser. No. 63/432,813 filed on 15 Dec. 2022, and European Application No. 23150931.6 filed on 10 Jan. 2023, each of which is incorporated by reference herein in its entirety.

### TECHNICAL FIELD

The present disclosure is directed to the general area of audio processing, and more particularly, to methods, apparatus and systems for performing environment-aware audio processing.

### BACKGROUND

Recently, environment-aware processing for audio and/or voice applications (or video applications comprising audio/voice) in mobile use cases has become a promising, yet widely unexplored technology.

Dynamic changes of environment and/or acoustic conditions may in some cases become one of the key problems for environment-aware processing and corresponding audio applications in mobile use cases. On the other hand, when the environment and/or acoustic condition is known, the corresponding audio processing could yield additional benefits, and provide better audio and voice quality to the end user.

In view thereof, generally speaking, there appears to exist a need for techniques of performing environment-aware processing of audio data for mobile devices.

### SUMMARY

In view of the above, the present disclosure generally provides a method of performing environment-aware processing of audio data for a mobile device, a corresponding apparatus, a program, as well as a computer-readable storage media, having the features of the respective independent claims.

According to a first aspect of the present disclosure, a method of performing environment-aware processing of audio data for a mobile device is provided. As can be understood and appreciated by the skilled person, the mobile device may include, but is certainly not limited to, a mobile phone, a table, a (portable) computer, or any other suitable device. The audio data may be data from an audio (or voice) application (e.g., a music application) or a video application that may comprise audio (or voice) data (e.g., a movie application).

In particular, the method may comprise obtaining non-acoustic sensor information of the mobile device. The method may further comprise determining scene information indicative of an environment of the mobile device based on the non-acoustic sensor information. As will be discussed in more detail below, the environment of the mobile device may comprise (but is certainly not limited to) an indoor environment, an outdoor environment, a transportation environment, a flight environment, or any other suitable classification of the environment. The method may yet further comprise performing audio processing of the audio data based on the determined scene information. As will be understood and appreciated by the skilled person, depending on various implementations and/or requirements, the audio processing may comprise, for example, dialogue enhancement (dialog enhancement), equalization (EQ), or any other suitable audio processing.

Configured as described above, the proposed method may generally provide an efficient yet flexible manner for performing environment-aware processing of audio data for mobile devices, thereby improving the audio quality that is perceived by the end user (of the mobile device). For instance, depending on the audio processing techniques (or component) involved (e.g., dialogue enhancement), the proposed method may improve the dialogue intelligibility experience of mobile audio playback for example under diverse noisy environments mobility use cases (e.g., in a subway). More particularly, compared to conventional techniques where acoustic-based method (e.g., noise compensation), the method proposed in the present disclosure generally exploits non-acoustic mobile sensor data/information (which could provide, among others, useful context information of the device, user, and/or environment), thereby enabling better environment-aware processing performance and better audio processing performance, especially in the daily commuting use cases.

In some example implementations, the non-acoustic sensor information may be obtained from one or more non-acoustic sensors of the mobile device.

In some example implementations, the one or more non-acoustic sensors may comprise (but are certainly not limited to) at least one of: an accelerometer, a gyroscope, or a Global Navigation Satellite System (GNSS) receiver (such as a Global Positioning System (GPS) receiver, a Global Navigation Satellite System (GLONASS) receiver, or the like). Certainly, as can be understood and appreciated by the skilled person, any other suitable non-acoustic sensor (or more broadly, non-acoustic (electronic) device/component/module) may be used depending on various implementations and/or requirements, which may include (but not limited thereto), Wi-Fi, Bluetooth, etc. In some possible cases, also suitable software-based modules/models, e.g., machine-learning-based, may be exploited (e.g., being used in conjunction with other hardware-based sensors or components) to aid activity detecting.

In some example implementations, the determination of the scene information based on the non-acoustic sensor information may involve processing of sensor data in the non-acoustic sensor information.

Particularly, in some example implementations, the processing of sensor data in the non-acoustic sensor information may comprise pre-processing the non-acoustic sensor information by at least one of: aligning timestamps of sensor data in the non-acoustic sensor information stemming from different non-acoustic sensors or identifying invalid sensor data in the non-acoustic sensor information. One of the possible rationales behind such pre-processing may lie in the fact that the various kinds of sensor data may generally be captured from different hardware or software modules, and/or even on different phones with different mobile operating systems (OSs) asynchronously. As a result, the (raw) sensor information or data so captured may be of different formats and/or with different timestamps. In addition, due to the hardware or software issues or the changing environmental conditions, some (historical) data may become outdated, obsolete, or missing in some cases, and consequently not be able to provide valid information/data as required (e.g., when certain data is missing for a long while).

In some example implementations, the processing of sensor data in the non-acoustic sensor information may also comprise refining the non-acoustic sensor information by at least one of: resampling or filtering of sensor data in the non-acoustic sensor information. Similar as noted above, such refinement may also become necessary especially when the sensor data coming from (e.g., captured by) different hardware or software modules that might be running with different sample rates.

In some example implementations, the processing of sensor data in the non-acoustic sensor information may also comprise determining a preliminary scene classification based on the non-acoustic sensor information; and determining a scene score indicative of the environment based on the preliminary scene classification.

In some example implementations, before the determination of the scene score, the method may further comprise post-processing the determined preliminary scene classification. Particularly, in some possible cases, the post-processing may involve identifying a transition between different environments. As some illustrative examples (but not as a limitation of any kind), the transition between different environments may be a transition (of the end user) from an indoor environment (e.g., inside an office) to an outdoor environment (e.g., on a street), a transition (of the end user) from an indoor environment to a transportation environment (e.g., a subway or a taxi), a transition (of the end user) from an outdoor environment to a transportation environment, etc. Correspondingly, the scene score may be determined based on the post-processed preliminary scene classification.

In some example implementations, the audio processing may involve attack and/or release smoothing of the audio data based on the transition. In other words, depending on the transition so identified (e.g., indoor to outdoor), different (audio) processing may need to be applied especially to the transition stage according to the acoustic changing status. For instance, one possible technique for the control of the transition processing may be to apply different attack/release times for different mobility scenes. Of course, as will be understood and appreciated by the skilled person, any other suitable mechanism/technique may be adopted as well, depending on various implementations and/or requirements.

In some example implementations, the audio processing may be further based on a transition of the scene information from first scene information indicative of a first environment of the mobile device to second scene information indicative of a second environment of the mobile device that is different from the first environment. For instance, in a possible scenario of transition from indoor to outdoor, faster responding may be considered helpful, particularly in view of the potential noisy acoustic condition in the outdoor environment. Similarly, in another possible scenario of transition from indoor to in-vehicle/transportation (e.g., metro), ed, a faster response may also be helpful, since the fast moving of the metro would typically bring more heavy noises to the users. As illustrated above, in such transition scenarios, different (audio) processing may need to be applied in accordance with the acoustic changing statuses, which may include (but is not limited to), applying different attack/release times for different mobility scenes.

In some example implementations, the scene information may be indicative of one of: an indoor environment, an outdoor environment, a transportation environment, or a flight environment. Certainly, as can be understood and appreciated by the skilled person, any other suitable scene/environment classification may be used, depending on various implementations and/or requirements.

In some example implementations, the audio processing may involve dialog enhancement. However, as has been noted above, any other suitable audio processing techniques (or corresponding components) may be applied as well, as will be understood and appreciated by the skilled person.

In some example implementations, the dialog enhancement may comprise determining at least one elementary dialog enhancement parameter based on the determined scene information, and optionally, also based on at least one predetermined (or predefined) dialog enhancement setting profile.

In some example implementations, the dialog enhancement may comprise determining an estimated noise level based on the determined scene information.

In some example implementations, the estimated noise level may be determined based on noise statistics and/or histogram information corresponding to the determined scene information. Notably, in some cases, dividing the (mobility) scenes for example into definitions of indoor/outdoor/transportation/flight (or the like) may be considered a somewhat rough division (classification), because the real acoustic condition could change even at the same mobility scene as classified as above for example in different time points or positions/locations. Thus, involvement of the rough noise level or noise profile (e.g., noise statistics and/or histogram information) could bring benefit to the final listening experience to some extent.

In some example implementations, the dialog enhancement may further comprise refining the elementary dialog enhancement parameter based on the estimated noise level to determine a refined dialog enhancement parameter for use in dialog enhancement applied to the audio data.

According to a second aspect of the present invention, an apparatus including a processor and a memory coupled to the processor is provided. The processor may be adapted to cause the apparatus to carry out all steps according to any of the example methods described in the foregoing aspect.

According to a third aspect of the present invention, a computer program is provided. The computer program may include instructions that, when executed by a processor, cause the processor to carry out all steps of the example methods described throughout the present disclosure.

According to a fourth aspect of the present invention, a computer-readable storage medium is provided. The computer-readable storage medium may store the aforementioned computer program.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF DRAWINGS

Example embodiments of the present disclosure are explained below with reference to the accompanying drawings, wherein like reference numbers indicate like or similar elements, and wherein

FIG. 1 is a schematic illustration showing a flow diagram of an example dialog enhancement system,

FIG. 2 is a schematic illustration showing an example implementation of a software architecture,

FIG. 3 is a schematic illustration showing an example flow diagram of a mobility scene classifier according to embodiments of the present disclosure,

FIGS. 4A and 4B are schematic illustrations showing example input and output of the implementation of the mobility scene classifier according to embodiments of the present disclosure,

FIG. 5 is a schematic illustration showing examples of possible scene transitions,

FIG. 6 is a schematic illustration showing an example flow diagram of a dialog enhancement according to embodiments of the present disclosure,

FIG. 7 is a schematic flowchart illustrating an example of a method of performing environment-aware processing of audio data for a mobile device according to embodiments of the present disclosure, and

FIG. 8 is a schematic block diagram of an example apparatus for performing methods according to embodiments of the present disclosure.

### DETAILED DESCRIPTION

As indicated above, identical or like reference numbers in the present disclosure may, unless indicated otherwise, indicate identical or like elements, such that repeated description thereof may be omitted for reasons of conciseness.

Particularly, the Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Furthermore, in the figures, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the present invention. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

Existing environment-aware processing techniques may dependent on acoustic audio data, which is generally captured from the acoustic sensor(s) of the mobile device. However, regarding various kinds of sensors equipped in a mobile device, it may be worthwhile to start paying attention also to non-acoustic sensor data, which could provide useful context information on the device, user, and environment.

In a broad sense, the present disclosure generally seeks to propose techniques to enable a smart signal (e.g., audio) processing (e.g., dialogue enhancement) which generally includes non-acoustic mobile sensor data or information, for better environment-aware processing performance and better audio processing performance, for example in the daily commuting use cases.

To be more specific, in order to improve the performance of audio processing (such as by the dialogue enhancer) in dynamically changing mobility use cases, the present disclosure generally proposes a first mobility scenes classification with pre-processed non-acoustic mobile sensor data, and then a subsequent automatic adjustment of the dialogue enhancer with post-processed mobility scenes classification, thereby achieving better environment-aware processing and audio processing performance within mobile devices, especially in (daily) commuting use-cases.

While the remainder of the present disclosure will frequently make reference to dialogue enhancement and dialogue enhancers, etc., it is understood that these serve as example of audio processing in general and that the present disclosure shall not be construed as being limited to dialogue enhancement.

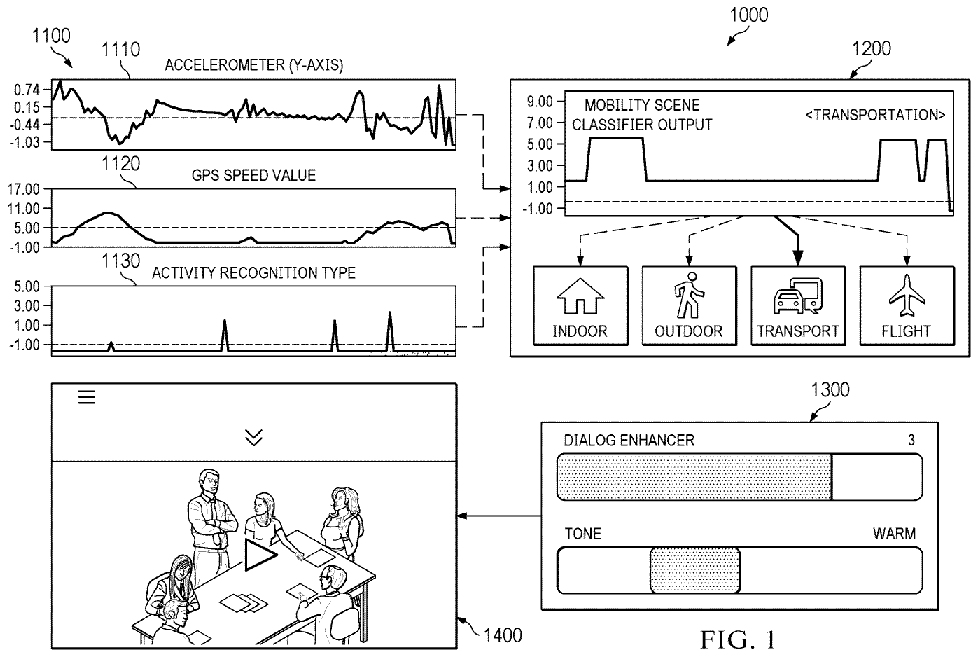

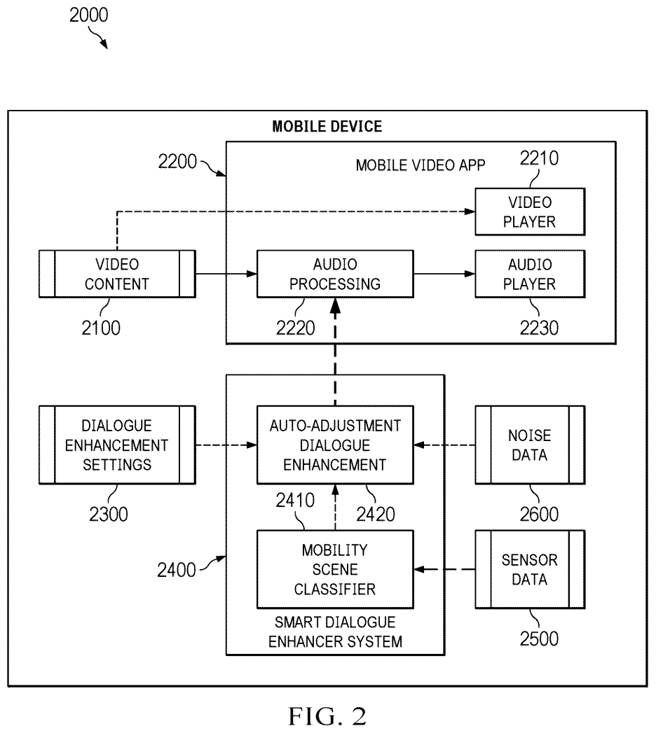

Referring now to the drawings, FIG. 1 is a schematic illustration showing a flow diagram 1000 of an example overall dialogue enhancement system (for example the dialogue enhancement system 2000 of FIG. 2 as will be discussed in more detail below). As \hat{ }noted above, any other suitable signal (audio/voice) processing techniques or components could be applicable as well in the context at hand (possibly with suitable adaptation, if necessary), as will be understood and appreciated by the skilled person.

Particularly, as illustrated in FIG. 1, in diagram 1100 sensor (more particularly, non-acoustic sensor) data/information of the mobile device (e.g., a mobile phone, a tablet, etc.) is obtained or gathered by using any suitable means (e.g., as shown in 2500 of FIG. 2). Notably, three possible kinds of non-acoustic sensor data, namely accelerometer data 1110, GPS speed value data 1120 and activity recognition type data (e.g., obtained by any suitable hardware/software module) 1130, are shown in the example of diagram 1110. However, as will be understood and appreciated by the skilled person, any other suitable non-acoustic sensor(s) (or more broadly, non-acoustic (electronic) device/component/module) may be used depending on various implementations and/or requirements, which may include (but is not limited thereto), Wi-Fi, Bluetooth, etc. In some possible cases, also suitable software-based modules/models, e.g., machine-learning-based, may be exploited (e.g., being used in conjunction with other hardware-based sensors or components) to aid such activity detection/recognition. It may be worthwhile to mention that in the case of GPS (or any other suitable GNSS) sensor data/information, it could be generally understood that typically the (raw) GPS data/information would not be directly used, but rather the (pre-)processed GPS data/information, e.g., the GPS speed value (as shown in 1120 of FIG. 1), the GPS accuracy, or any other suitable information.

Subsequently, in diagram 1200 a (mobility) scene/environment classification step is performed (e.g., by the mobility scene classifier 2410 of FIG. 2). Therein, all the (raw and/or pre-processed) sensor data/information gathered in diagram 1110 may be (further/post) processed as appropriate, and as a result, corresponding scene information indicative of an environment of the mobile device may be obtained. Such scene information may for example be in the form of a score (e.g., confidence score) or in any other suitable form. The environment of the mobile device may be (but is not necessarily limited to) indicative of an indoor environment, an outdoor environment, a transportation environment, a flight environment, or any other suitable scene/environment classification. Notably, in the present disclosure the scene/environment of “flight” or “in flight” may be separate from the general classification of “transportation” scene/environment. Thus, unless indicated otherwise, in the present disclosure the “transportation” scene/environment is generally used to refer to transportation means other than flight/planes, which may include (but is certainly not limited to) cars, metro/subways, buses, etc. One of the main reasons why the “flight” and “transportation” scenes are (intentionally) separated/distinguished in the present disclosure lies in the fact that there would typically exhibit strong but stable (background) noises (more particularly in the low frequency range) in flight scenarios, which would then naturally result in a different scene/environment classification output by the techniques described in the present disclosure (i.e., by exploiting the non-acoustic sensor data), and/or which may require different audio processing. In addition, it may also be worthwhile to note that, in some possible implementations, the “flight” scene may even be detected by means as simple as identifying that the mobile device is operated in the so-called “flight mode” (e.g., an operation mode where transmission/reception functionalities of the mobile device are turned off).

Once the mobility scene has been determined in diagram 1200, the audio enhancement setting(s) may be adjusted or refined in diagram 1300 (e.g., by the auto-adjustment dialogue enhancement module 2420 of FIG. 2) based on the classified mobility scene. Notably, in some possible implementations, one or more (predefined or predetermined) elementary audio processing profiles (e.g., the dialogue enhancement settings 2300 of FIG. 2) may be used as well to aid the audio/dialogue enhancement processing. As an illustrative example, in such adjustment or refinement of the audio/dialogue enhancement processing 1300, it may be determined to which loudness level the voice may have to be boosted, depending on the classified environment of the mobile device (e.g., when detecting that the end user of the mobile device is now on a subway). As another illustrative example, when the end user of the mobile device is an elderly person (possibly with hearing problems), it may have to be determined to boost the voice more in the low frequency range than in the high frequency range in certain scenarios.

After such audio/dialogue enhancement processing in 1300, the determined (e.g., adjusted or refined) settings or profiles may be subsequently fed to a corresponding audio or video application on the mobile device for audio enhancement and/or the final playback as shown in diagram 1400.

Now reference is made to FIG. 2, which schematically illustrates an example of a software-based system architecture 2000 that may be suitable for implementing the aforementioned audio/dialogue enhancement system as described in FIG. 1. Such system 2000 may be part of a mobile device (e.g., a mobile phone or a tablet). It is also to be noted that the system architecture 2000 as shown in FIG. 2 merely represents one possible implementation thereof, any other suitable implementation may of course be feasible as well.

As can be seen from FIG. 2, the software architecture 2000 comprises, among others, a main functional component/module 2400, which itself comprises two main parts, namely a mobile (non-acoustic) sensor-driven mobility scenes classifier 2410, and a mobility scenes event driven dialogue enhancer 2420.

More particularly, as has been described above with reference to FIG. 1, the mobility scene classifier 2410 is generally configured to detect scenes (such as “indoor”/“outdoor”/“transportation”/“flight” etc.) based on the mobile (non-acoustic) sensor data 2500. Notably, although not shown in FIG. 2, depending on various implementations, the mobility scene classifier 2410 itself may comprise one or more sub-modules including (but not limited to) for example pre-processing of (raw) sensor data, basic classification of mobility scenes event, post-processing of event transition stage, etc.

On the other hand, automatic adjustment of dialogue is performed by the auto-adjustment dialogue enhancement module 2420 to potentially enhance the audio experience in mobility use case(s), based on the mobility scene event output by the mobility scene classifier module 2410. Further input(s), such as information or data indicative of noise level measurement 2600 and/or (predefined/pre-determined) elementary audio processing profile(s) 2300, may be fed into the auto-adjustment dialogue enhancement module 2420, thereby aiding the adjustment or refinement of the dialogue enhancement setting(s).

Once the auto-adjustment dialogue enhancement module 2420 finishes the adjustment and/or refinement of the dialogue enhancement setting(s), the result is output to the mobile application 2200 for (further) processing. Notably, in the example of FIG. 2, the mobile application 2200 is shown to be a mobile video application. However, as will be understood and appreciated by the skilled person, any other suitable applications (e.g., an audio applications) may be used as well in the context of the present disclosure.

The mobile video application 2200 receives an input video content 2100. Thereafter, the audio (voice) part of the video content 2100 is fed into the audio processing chain 2220 where the adjusted and/or refined dialogue enhancement setting(s) will be used to apply dialogue enhancement to thereby enhance the user experience of the audio being played back at the audio player 2230. On the other hand, the video part of the video content 2100 may be (directly) fed into the video player 2210 for playback.

Next, examples of possible implementations regarding the mobility scenes classifier as well as the mobility scene event-driven dialogue enhancer will be discussed in more detail below with reference to the subsequent figures.

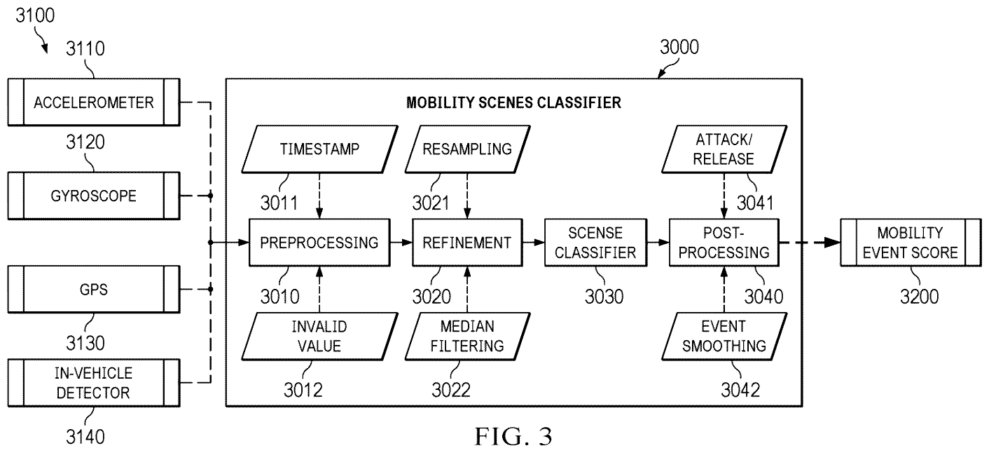

In particular, FIG. 3 is a schematic illustration showing an example flow diagram of a mobility scene classifier 3000 according to embodiments of the present disclosure. Notably, the mobility scene classifier 3000 of FIG. 3 may be considered to represent one possible way for implementing the mobility scene classifier module 2410 as shown in FIG. 2.

Generally speaking, in the example implementation shown in FIG. 3, the mobility scene classifier 3000 may receive (raw) sensor data/information 3100 from various non-acoustic sensors of the mobile device. As has been illustrated above, the non-acoustic sensors may include, but are certainly not limited to, accelerometer 3110, gyroscope 3120, GPS 3130, or in-vehicle detector 3140 (which may be hardware and/or software-based), etc. Moreover, in the example implementation shown in FIG. 3, the mobility scene classifier 3000 may also output a mobility event score 3200, which may be used to indicate the environment (e.g., indoor, outdoor, etc.) of the mobile device. Of course, any other suitable information (other than the event score 3200) being capable of indicating or representing the corresponding environment or scene of the mobile device may be adopted as well, as can be understood and appreciated by the skilled person.

Returning to the mobility scene classifier 3000 itself, in the example shown in FIG. 3 the mobility scene classifier 3000 may comprise a number of (e.g., 4) sub-modules that jointly (e.g., sequentially, parallelly, or in any other suitable order) process the input (raw) non-acoustic sensor data 3100 and generate the output mobility event score 3200.

A first module or functional block thereof may be referred to as the pre-processing module 3010 that may be mainly configured for pre-processing of the received (raw) sensor data 3100. In some possible implementations, the sensor data 3100 that originates from various sources (e.g., different non-acoustic sensors) may have already been fused. In such cases, the pre-processing may be performed on said fused sensor data. Notably, one possible rationale behind such pre-processing may lie in the fact that various kinds of sensor data may typically be asynchronously captured from different hardware or software modules and/or on different phones with different mobile operating systems (OSs).

In consequence, one possible resulting issue may relate to the timestamps relating to the sensor data obtained from various sources (as exemplarily shown in block 3011). For instance, the respective data format of timestamps might be different, the respective time zone might be different, the respective calculation method might be different, etc. As an illustrative example for ease of understanding, one possible kind of timing calculation on one particular kind of smartphone might for instance be based on elapsed duration since the phone has been rebooted, which may be different from the calculation method adopted on other mobile device(s) or by other modules. Consequently, establishing a unified time format may become necessary in the pre-processing step. In some possible implementations, when the sampling interval should be less than one second, the elapsed time from for example 1970/1/1 UTC may be used with units of milliseconds. Of course, depending on various implementations and/or requirements, any other mechanism for providing a unified time format representing the timestamps of the sensor data from various sources may be adopted as well. In general, this processing may be said to relate to time-aligning the sensor data from different sources, or to providing a unified time reference that enables time-alignment of the sensor data.

Another possible issue may arise from data loss (as exemplarily shown as block 3012), for example due to hardware and/or software issue(s) or changes in environmental condition(s). For instance, in some possible cases, the mobility scenes classification module may be kept running continuously, no matter whether data is missing or not. As a result, in certain cases, the historical data might not be able to provide valid information anymore particularly when the data has been missing for an extended period of time. Consequently, in some possible implementations, a specific invalid flag might be added to the sensor data sequence. More specifically, in some possible implementations, the maximum negative value (which is generally considered out of range) may be used to indicate such abnormal status in data missing cases. Of course, as can be understood and appreciated by the skilled person, any other suitable (pre-)processing mechanism may be implemented as well depending on various circumstances and/or requirements. In general, the proposed technique may provide an indicator (e.g., flag) indicating missing data from one or more sensors.

A second module may be referred to as the refinement module 3020 that may be mainly configured for refining the non-acoustic sensor information (or in some possible implementations, the pre-processed sensor data from block 3010). As can be understood and appreciated by the skilled person, such refinement may include, but is certainly not limited to, re-sampling, alignment, filtering, and/or any other suitable processing.

Particularly, the sensor data may come from different hardware and/or software modules (or different sources in general), which themselves may be configured to be running with different sample rates. In such cases, the re-sampling process of the sensor data may become necessary for the subsequent classification calculation. In some possible implementations, an interval value of one second (or any other suitable duration value) may be chosen for the re-sampling (as exemplarily shown as block 3021), and a median filter (as exemplarily shown as block 3022) may be used for re-sampling for sensors whose sample-rate is less than one second or even less than half a second. In some possible implementations, all the invalid flag data that has been prepared in the previous module 3010 as illustrated above may be kept during the resampling process, for example if there appears to be no valid sensor data in one specific resampling interval. Of course, as can be understood and appreciated by the skilled person, any other suitable refinement mechanism may be implemented as well depending on various circumstances and/or requirements.

Further, a third module may be referred to as the scene classifier module 3030 that may be mainly configured for determining a preliminary scene classification based on the non-acoustic sensor information (or in some possible implementations, based on the refined sensor data from block 3020). In some possible implementations, certain sensor data/information such as motion sensor data and/or in-vehicle (activity) detection data may be considered as key input(s) for the mobility scenes classifier 3030. More specifically, depending on various implementations, the motion sensor data may include (but is not limited to) acceleration data, angle speed data, GPS accuracy data, and/or GPS speed data. On the other hand, the in-vehicle detection data could for example be obtained directly from some (advanced) software service of the mobile device, or from some standalone signal processing module e.g., with traditional and/or machine learning based methods implemented thereon.

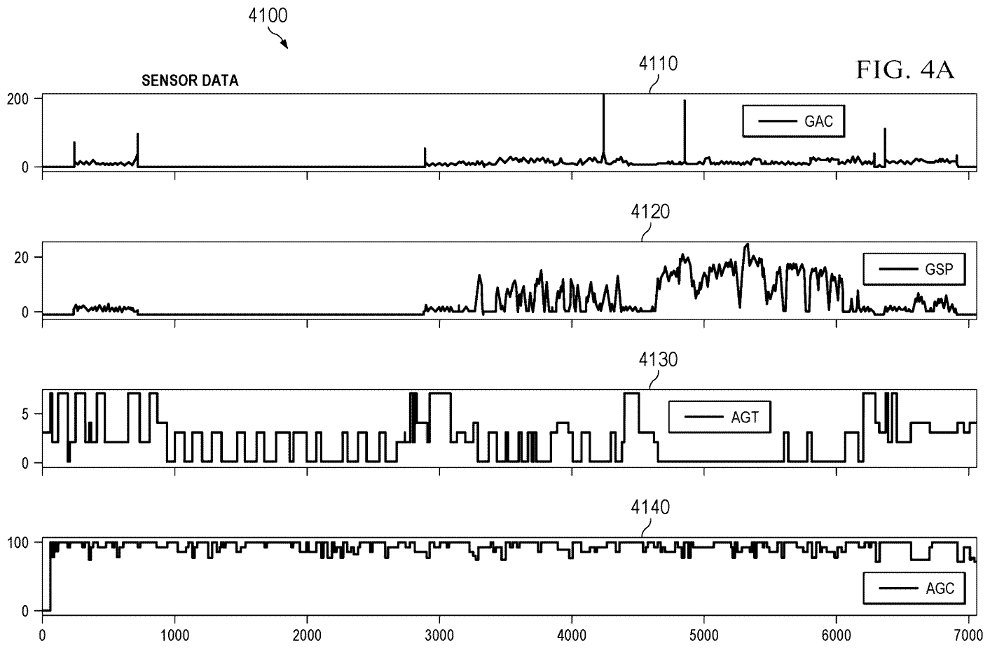

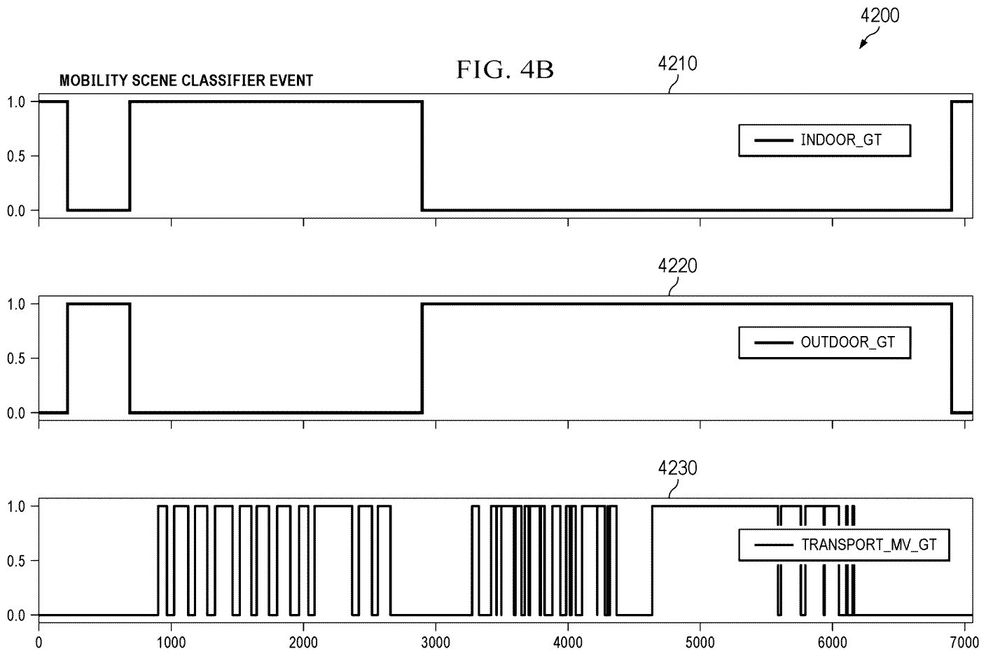

Optionally, in some possible implementations, corresponding mobility scene event score data might be directly given as an output of such scene classifier module 3030 (i.e., thereby omitting the post-processing module 3040). FIGS. 4A and 4B schematically illustrate possible example input and output diagrams 4100 and 4200 of a possible implementation of the mobility scene classifier according to embodiments of the present disclosure.

In particular, FIG. 4A schematically shows some possible input sensor data (whether refined or not), which may include (but is not limited to) GPS accuracy data 4110 (indicated as “GAC”), GPS speed data (indicated as “GSP”), activity type data 4130 (indicated as “AGT”), and activity confidence data 4140 (indicated as “AGC”). Of course, as will be understood and appreciated by the skilled person, any other suitable (non-acoustic) sensor data/information (as illustrated above) may be exploited, depending on various implementations and/or requirements.

Correspondingly, FIG. 4B schematically shows some possible output of the mobility scene classifier event that may be determined by the scene classifier module 3030 of FIG. 3, which may include (but is not limited to) “indoor” scene/environment 4210 (indicated as “INDOOR_GT”), “outdoor” scene/environment 4220 (indicated as “OUTDOOR_GT”), and “transportation” scene/environment 4230 (indicated as “TRANSPORT_MV_GT”). Notably, the mobility scene event score may be determined by using any suitable means. For instance, in some possible implementations, the mobility scene event score may be determined by comparing the (refined or not) sensor data with one or more thresholds (e.g., predefined or predetermined in accordance with the type/source of the sensor data). Of course, as can be understood and appreciated by the skilled person, these output diagrams 4210 to 4230 as shown in FIG. 4B as well as those input diagrams 4110 to 4140 as shown in FIG. 4A are merely for illustrative purposes and should in no way be considered as limiting for the actual implementations.

Returning to FIG. 3, in some possible implementations, an (optional) fourth post-processing module 3040 may be present prior to the generation of the final scene score 3200 indicative of the environment of the mobile device. Such post-processing may be considered beneficial or necessary, particularly in cases where mobility scene transition occurs, due to the fact that different listening sensitivity of the acoustic condition might change accordingly to the new mobility scene.

One illustrative example for understanding such a transition stage might be the case when transiting from an indoor environment to an outdoor environment. During such transition stage, a faster response may be considered helpful, in view of the potentially (more) noisy acoustic conditions in the outdoor environment (compared to the indoor environment). Another possible example may be the case when transiting from an indoor environment to an in-vehicle/transportation environment (e.g., in the metro). In such cases, when the transportation event is detected, a faster response may also be helpful since movement of the metro and/or other passengers therein would typically bring heavier noise to the end users.

Consequently, different processing techniques may have to be applied to such transition stage, according to the general acoustic changing status. In some possible implementations for controlling the transition processing, it may be proposed for example to apply different attack/release times for different mobility scenes (as exemplarily shown in block 3041) or to smooth (e.g., by using any suitable signal processing) those transition stages/events (as exemplarily shown as block 3042). Of course, as can be understood and appreciated by the skilled person, any other suitable post-processing mechanism may be applied, depending on various implementations and/or requirements. In general, the audio processing may be adapted depending on whether a scene transition is detected, and optionally, based on the specific type of scene transition that is detected. At this, the audio processing may involve attack and/or release smoothing of the audio data based on the transition.

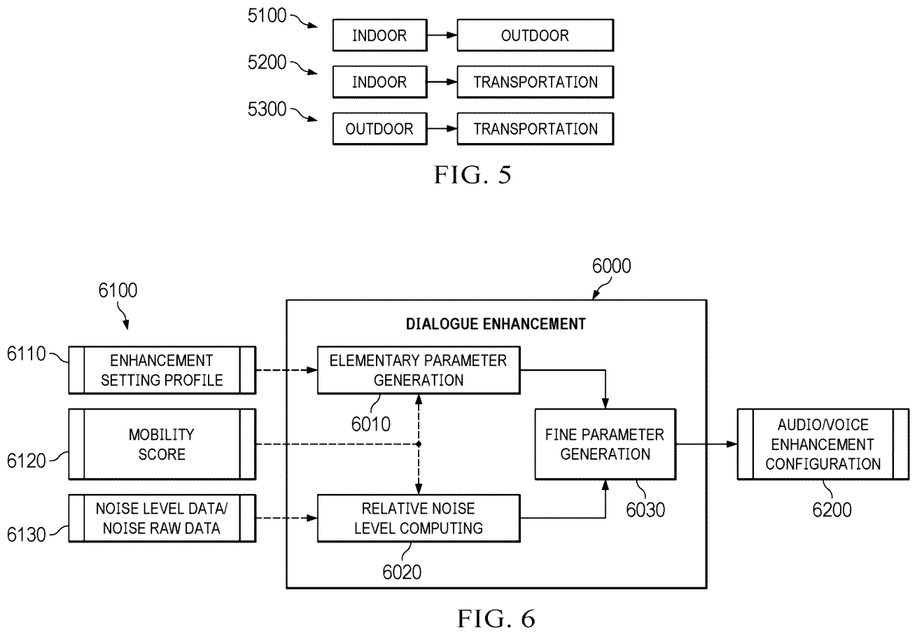

FIG. 5 is a schematic illustration showing examples of possible scene transitions where specific post-processing (e.g., fast responding, different attack/release time, smoothing, etc.) may be considered applicable. Particularly, such transitions may include (but are certainly not limited to) transition from an indoor environment to an outdoor environment 5100, a transition from an indoor environment to a transportation environment 5200, and a transition from an outdoor environment to a transportation environment 5300. Of course, depending on various implementations (e.g., how the scenes/environments are classified), other suitable transitions may be possible as well.

For the sake of completeness, it may be worthwhile to mention that although the example mobility scenes classifier 3000 is implemented with a total number of four sub-modules 3010 to 3040 that are organized in a sequential manner, these sub-modules may be organized in any other suitable manner or order, as can be understood and appreciated by the skilled person. For instance, some of the sub-modules (e.g., the post-processing module 3040) may be (intentionally) omitted, or some of the currently presented sub-modules may be combined into a larger module or component. In other words, the actual implementation of the mobility scenes classifier should not be considered to be limited to the example as shown in FIG. 3. In general, it is sufficient that the mobility scenes classifier 3000 is adapted to perform the respective functionalities.

Once the mobility event/scene indicative of the environment of the mobile device has been determined based on the non-acoustic sensor information (e.g., in the form of an output mobility event score), such scene information may be subsequently fed into a dialogue enhancement module (e.g., the auto-adjustment dialogue enhancement 2420 as shown in FIG. 2), possibly together with other suitable inputs. It is emphasized again that the dialogue enhancement module is taken to be as an example of a module for audio processing, and that the present disclosure should be understood as relating to audio processing techniques other than dialogue enhancement as well.

Now with reference to FIG. 6, a schematic illustration showing an example implementation diagram of a (mobility scene event-driven) dialogue enhancer 6000 according to embodiments of the present disclosure will be discussed. Similar to FIG. 3, the mobility-scene-event-driven dialogue enhancer 6000 of FIG. 6 may be considered to represent one possible way for implementing the auto-adjustment dialogue enhancement 2420 as shown in FIG. 2.

As can be seen from the example of FIG. 6, the dialogue enhancer 6000 may receive input data 6100 which may include the mobility scene event score 6120 (e.g., the mobility event score 3200 as shown in FIG. 3), optionally also one (or more) pre-defined enhancement setting profile(s) 6110 as well as noise level data 6130 may be processed by the dialogue enhancer 6000. As a result, the dialogue enhancer may generate a final fine-tuned enhancement configuration 6200 for playback at the respective audio/voice application.

More particularly, in the example as shown in FIG. 6, the dialogue enhancer 6000 may comprise a number of (e.g., 3) sub-modules that jointly (e.g., sequentially or in any other suitable order) process the input data 6100 and output the final audio/voice enhancement configuration 6200.

To be more specific, a first module or functional block may be referred to as the elementary parameter generation module 6010 that may be mainly configured for elementary parameter(s) switching of the dialogue enhancer based on mobility scene event 6120. In some possible implementations, one or more pre-defined dialogue enhancement setting profiles 6110 may be selected based on the mobility scene event output (score) 6120. In other words, selection may be made from a set of pre-defined dialogue enhancement setting profiles. As can be understood and appreciated by the skilled person, the elementary parameters may include (but are not limited to) settings related to loudness, aggressiveness, tone, etc., or any other suitable elementary parameters. Notably, the output of transition stage processing (e.g., by the post-processing module 3040 of FIG. 3) as illustrated above might also provide added benefit for a smooth listening experience during the transition stage.

In a second relative noise level computing module 6020, the noise level may be determined (e.g., computed or estimated) based on the input (raw) noise related data 6130.

Notably, the division or classification of the mobility scenes into definitions of “indoor”/“outdoor”/“transportation”/“flight”, for example, may in some cases be considered as not fully strict or precise due to the fact that the real acoustic condition might possibly change even at the same mobility scene for example in different time points or positions/locations.

Therefore, in some possible implementations, it may be an option to consider involving the rough noise level or noise profile for the benefit of the final listening experience perceived by the end user of the mobile device. For instance, in some possible implementations, the noise level may be computed or estimated based on noise statistics and/or histogram information corresponding to the respective mobility scene event.

In some possible implementations, the noise level analysis might simply focus on the low frequency part, which is generally considered the main frequency range in which noise signals are present. Similarly, the relevant computing could focus on the histogram or other statistics information in the relevant long-time segment. For instance, in some possible implementations, the noise level or profile could be simply divided into three levels (e.g., in the form of low/medium/high), in order to possibly avoid added computing complexity.

Based on the computed noise level or profile from module 6020 and the elementary parameter profile from module 6010, the corresponding fine adjustment could be computed and smoothed in a third fine parameter generation module 6030, thereby generating the output audio/voice enhancement configuration 6200 that could eventually be applied to the dialogue enhancer or other suitable audio/voice processing module, in order to yield the desired performance in the aforementioned dynamically changed mobility use cases.

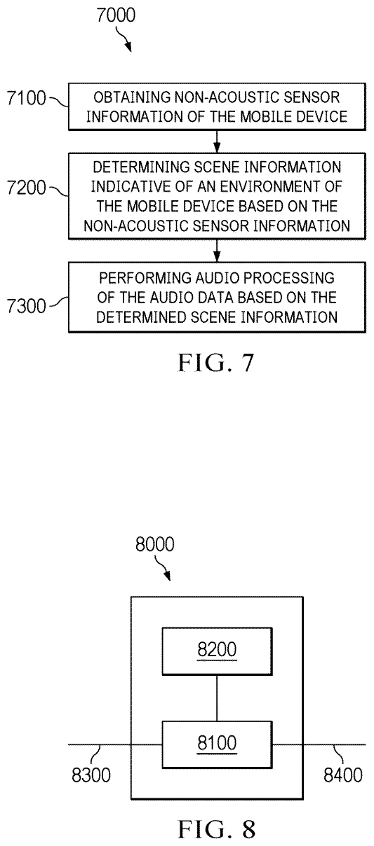

FIG. 7 is a schematic flowchart illustrating an example of a method 7000 of performing environment-aware processing of audio data for a mobile device according to embodiments of the present disclosure.

In particular, the method 7000 as shown in FIG. 7 may start at step 7100 by obtaining non-acoustic sensor information of the mobile device. Subsequently, in step 7200 the method 7000 may comprise determining scene information indicative of an environment of the mobile device based on the non-acoustic sensor information. As has been illustrated above, the environment of the mobile device may comprise (but is certainly not limited to) an indoor environment, an outdoor environment, a transportation environment, a flight environment, or any other suitable classification of the environment. The method 7000 may yet further comprise at step 7300 performing audio processing of the audio data based on the determined scene information. As will be understood and appreciated by the skilled person, depending on various implementations and/or requirements, the audio processing may comprise, for example dialogue enhancement, equalization (EQ), or any other suitable audio processing.

Configured as described above, the proposed method may generally provide an efficient yet flexible manner for performing environment-aware processing of audio data for mobile devices, thereby improving the audio quality that is perceived by the end user (of the mobile device). For instance, depending on the audio processing techniques (or components) involved (e.g., dialogue enhancement), the proposed method may improve the dialogue intelligibility experience of mobile audio playback for example under diverse noisy environments mobility use cases (e.g., in a subway, in a car, etc.). More particularly, compared to conventional techniques where acoustic-based methods (e.g., noise compensation) are applied, the method proposed in the present disclosure generally exploits non-acoustic mobile sensor data/information (which could provide, among others, useful context information of the device, user, and/or environment), thereby enabling better environment-aware processing performance and better audio processing performance, especially in the daily commuting use cases.

Finally, the present disclosure likewise relates to apparatus for performing methods and techniques described throughout the present disclosure. FIG. 8 generally shows an example of such apparatus 8000. In particular, apparatus 8000 comprises a processor 8100 and a memory 8200 coupled to the processor 8100. The memory 8200 may store instructions for the processor 8100. The processor 8100 may also receive, among others, suitable input data (e.g., audio/video input, non-acoustic sensor data/information, noise data, etc.), depending on various use cases and/or implementations. The processor 8100 may be adapted to carry out the methods/techniques (e.g., method 7000 as illustrated above with reference to FIG. 7) described throughout the present disclosure and to generate correspondingly output data 8400 (e.g., dialogue enhances audio/video output, etc.), depending on various use cases and/or implementations.

### Interpretation

A computing device implementing the techniques described above can have the following example architecture. Other architectures are possible, including architectures with more or fewer components. In some implementations, the example architecture includes one or more processors (e.g., dual-core Intel® Xeon® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present invention discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this invention to “one example embodiment”, “some example embodiments” or “an example embodiment” means that a particular feature, structure or characteristic described in connection with the example embodiment is included in at least one example embodiment of the present invention. Thus, appearances of the phrases “in one example embodiment”, “in some example embodiments” or “in an example embodiment” in various places throughout this invention are not necessarily all referring to the same example embodiment. Furthermore, the particular features, structures or characteristics may be combined in any suitable manner, as would be apparent to one of ordinary skill in the art from this invention, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present invention, various features of the present invention are sometimes grouped together in a single example embodiment, Fig., or description thereof for the purpose of streamlining the present invention and aiding in the understanding of one or more of the various inventive aspects. This method of invention, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this invention.

Furthermore, while some example embodiments described herein include some but not other features included in other example embodiments, combinations of features of different example embodiments are meant to be within the scope of the present invention, and form different example embodiments, as would be understood by those skilled in the art. For example, in the following claims, any of the claimed example embodiments can be used in any combination.

In the description provided herein, numerous specific details are set forth. However, it is understood that example embodiments of the present invention may be practiced without these specific details. In other instances, well-known methods, structures and techniques have not been shown in detail in order not to obscure an understanding of this description.

Thus, while there has been described what are believed to be the best modes of the present invention, those skilled in the art will recognize that other and further modifications may be made thereto without departing from the spirit of the present invention, and it is intended to claim all such changes and modifications as fall within the scope of the present invention. For example, any formulas given above are merely representative of procedures that may be used. Functionality may be added or deleted from the block diagrams and operations may be interchanged among functional blocks. Steps may be added or deleted to methods described within the scope of the present disclosure.

Example embodiments of the present disclosure have been described above in relation to methods and systems for determining an indication of an audio quality of an audio input. Such methods and systems include:

A smart dialogue enhancement method and system including non-acoustic mobile sensor comprising any or all of:
1) A mobility scene classifier to detect scenes of Indoor/Outdoor/Transportation/Flight, based on mobile sensor data, including:
   a) feature extraction of simple sensor data and fused sensor data;
   b) pre-processing of sensor feature data for event classifier, including re-sampling, time alignment and filtering;
   c) event classification of Indoor/Outdoor/Transportation/Flight bases on sensor features; and
   d) post-processing of mobility scene event, such as transition smoothing at attack and release stage, and
2) An automatic adjustment of dialogue enhancer, based on mobility scenes event data and noise level, including:
   a) elemental parameters switching of dialogue enhancer based on mobility scene event;
   b) noise level computing based on noise statistics or histogram info based on mobility scene event; and
   c) refined parameters adjustment of dialogue enhancer based on noise level.

Various aspects of the present invention may be appreciated from the following Enumerated Example Embodiments (EEEs):
EEE1. A method of performing environment-aware processing of audio data for a mobile device, comprising:
obtaining non-acoustic sensor information of the mobile device;
determining scene information indicative of an environment of the mobile device based on the non-acoustic sensor information; and
performing audio processing of the audio data based on the determined scene information.
EEE2. The method according to EEE1, wherein the non-acoustic sensor information is obtained from one or more non-acoustic sensors of the mobile device.
EEE3. The method according to EEE2, wherein the one or more non-acoustic sensors comprise at least one of: an accelerometer, a gyroscope, or a Global Navigation Satellite System, GNSS, receiver.
EEE4. The method according to any one of the preceding EEEs, wherein the determination of the scene information based on the non-acoustic sensor information involves processing of sensor data in the non-acoustic sensor information.
EEE5. The method according to EEE4, wherein the processing of sensor data in the non-acoustic sensor information comprises:
pre-processing the non-acoustic sensor information by at least one of: aligning timestamps of sensor data in the non-acoustic sensor information stemming from different non-acoustic sensors, or identifying invalid sensor data in the non-acoustic sensor information.
EEE6. The method according to EEE4 or EEE5, wherein the processing of sensor data in the non-acoustic sensor information comprises:
refining the non-acoustic sensor information by at least one of: resampling or filtering of sensor data in the non-acoustic sensor information.
EEE7. The method according to any one of EEE4 to EEE6, wherein the processing of sensor data in the non-acoustic sensor information comprises:
determining a preliminary scene classification based on the non-acoustic sensor information; and
determining a scene score indicative of the environment based on the preliminary scene classification.
EEE8. The method according to EEE7, wherein, before the determination of the scene score, the method further comprises post-processing the determined preliminary scene classification;
wherein the post-processing involves identifying a transition between different environments; and
wherein the scene score is determined based on the post-processed preliminary scene classification.
EEE9. The method according to EEE8, wherein the audio processing involves attack and/or release smoothing of the audio data based on the transition.
EEE10. The method according to any one of the preceding EEEs, wherein the audio processing is further based on a transition of the scene information from first scene information indicative of a first environment of the mobile device to second scene information indicative of a second environment of the mobile device that is different from the first environment.
EEE11. The method according to any one of the preceding EEEs, wherein the scene information is indicative of one of: an indoor environment, an outdoor environment, a transportation environment, or a flight environment.
EEE12. The method according to any one of the preceding EEEs, wherein the audio processing involves dialog enhancement.
EEE13. The method according to EEE12, wherein the dialog enhancement comprises:
determining at least one elementary dialog enhancement parameter based on the determined scene information and optionally, based on at least one predetermined dialog enhancement setting profile.
EEE14. The method according to EEE13, wherein the dialog enhancement further comprises:
determining an estimated noise level based on the determined scene information.
EEE15. The method according to EEE14, wherein the estimated noise level is determined based on noise statistics and/or histogram information corresponding to the determined scene information.
EEE16. The method according to EEE14 or 15, wherein the dialog enhancement further comprises:
refining the elementary dialog enhancement parameter based on the estimated noise level to determine a refined dialog enhancement parameter for use in dialog enhancement applied to the audio data.
EEE17. An apparatus, comprising a processor and a memory coupled to the processor, wherein the processor is adapted to cause the apparatus to carry out the method according to any one of the proceeding EEEs.
EEE18. A program comprising instructions that, when executed by a processor, cause the processor to carry out the method according to any one of EEEs 1 to 16.
EEE19. A computer-readable storage medium storing the program according to EEE18.

1. A method of performing environment-aware processing of audio data for a mobile device, comprising:
obtaining non-acoustic sensor information of the mobile device;
determining scene information comprising a scene classification indicative of an environment of the mobile device based on the non-acoustic sensor information; and
performing audio processing of the audio data based on the determined scene information, wherein the audio processing is adapted when a scene transition between any two of a plurality of scene classifications is detected and further adapted in a transition stage between the two scene classifications according to the specific type of scene transition detected.

2. The method according to claim 1, wherein the non-acoustic sensor information is obtained from one or more non-acoustic sensors of the mobile device.

3. The method according to claim 2, wherein the one or more non-acoustic sensors comprise at least one of: an accelerometer, a gyroscope, or a Global Navigation Satellite System, GNSS, receiver.

4. The method according to claim 1, wherein the determination of the scene information based on the non-acoustic sensor information involves processing of sensor data in the non-acoustic sensor information.

5. The method according to claim 4, wherein the processing of sensor data in the non-acoustic sensor information comprises:
pre-processing the non-acoustic sensor information by at least one of: aligning timestamps of sensor data in the non-acoustic sensor information stemming from different non-acoustic sensors, or identifying invalid sensor data in the non-acoustic sensor information.

6. The method according to claim 4, wherein the processing of sensor data in the non-acoustic sensor information comprises:
refining the non-acoustic sensor information by at least one of: resampling or filtering of sensor data in the non-acoustic sensor information.

7. The method according to claim 4, wherein the processing of sensor data in the non-acoustic sensor information comprises:
determining a preliminary scene classification based on the non-acoustic sensor information; and
determining a scene score indicative of the environment based on the preliminary scene classification.

8. The method according to claim 7, wherein, before the determination of the scene score, the method further comprises post-processing the determined preliminary scene classification;
wherein the post-processing involves identifying a transition between different environments; and
wherein the scene score is determined based on the post-processed preliminary scene classification.

9. The method according to claim 8, wherein the audio processing involves attack and/or release smoothing of the audio data based on the transition.

10. The method according to claim 1, wherein the audio processing is further based on a transition of the scene information from first scene information indicative of a first environment of the mobile device to second scene information indicative of a second environment of the mobile device that is different from the first environment.

11. The method according to claim 1, wherein the scene information comprising a scene classification is indicative of one of: an indoor environment, an outdoor environment, a transportation environment, or a flight environment.

12. The method according to claim 1, wherein the audio processing involves dialog enhancement.

13. The method according to claim 12, wherein the dialog enhancement comprises:
determining at least one elementary dialog enhancement parameter based on the determined scene information and optionally, based on at least one predetermined dialog enhancement setting profile.

14. The method according to claim 13, wherein the dialog enhancement further comprises:
determining an estimated noise level based on the determined scene information.

15. The method according to claim 14, wherein the estimated noise level is determined based on noise statistics and/or histogram information corresponding to the determined scene information.

16. The method according to claim 14, wherein the dialog enhancement further comprises:
refining the elementary dialog enhancement parameter based on the estimated noise level to determine a refined dialog enhancement parameter for use in dialog enhancement applied to the audio data.

17. An apparatus, comprising a processor and a memory coupled to the processor, wherein the processor is adapted to cause the apparatus:
obtain non-acoustic sensor information of a mobile device;
determine scene information comprising a scene classification indicative of an environment of the mobile device based on the non-acoustic sensor information; and
perform audio processing of the audio data based on the determined scene information, wherein the audio processing is adapted when a scene transition between any two of a plurality of scene classifications is detected and further adapted in a transition stage between the two scene classifications according to the specific type of scene transition detected.

18. A non-transitory computer-readable storage medium storing a program for performing environment-aware processing of audio data for a mobile device, the program comprising instructions that, when executed by a processor, cause the processor to:
obtain non-acoustic sensor information of a mobile device;
determine scene information comprising a scene classification indicative of an environment of the mobile device based on the non-acoustic sensor information; and
perform audio processing of the audio data based on the determined scene information, wherein the audio processing is adapted when a scene transition between any two of a plurality of scene classifications is detected and further adapted in a transition stage between the two scene classifications according to the specific type of scene transition detected.

19. (canceled)
